(19) United States
(12) Patent Application Publication
(10) Pub. No.: US 2021/0331797 A1
(43) Pub. Date: Oct. 28, 2021

(54) FLYING SAUCER AIRCRAFT

(71) Applicant: Qizhi Geng, Urumqi (CN)

(72) Inventor: Qizhi Geng, Urumqi (CN)

(21) Appl. No.: 17/170,918

(22) Filed: Feb. 9, 2021

(30) Foreign Application Priority Data
Apr. 26, 2020 (CN) 202010336463.0

(51) Int. Cl. B64C 39/00; B64D 27/20; B64D 27/24; B64D 47/02

(52) U.S. Cl. CPC B64C 39/001; B64D 27/20; B64C 39/006; B64D 47/02; B64D 27/24

(57) ABSTRACT

The invention discloses a flying saucer aircraft, comprising a saucer body, a flying paddle, and landing brackets, wherein the middle of the egg-shaped saucer body is provided with an electromagnetic track with the central portion recessed inward, which is provided with an electromagnetic levitation vehicle; the flying paddle is connected to the outer surface of the vehicle, and can be driven by the vehicle to rotate; turbojet brackets are further provided on both sides of the egg-shaped saucer body; the turbojet bracket is connected with a turbojet; the landing brackets are arranged at the bottom of the egg-shaped saucer body. The aircraft can be used as a new aircraft for transportation, travel, exploration and other activities; the aircraft does not need a special runway for take-off and landing, it can take off and land vertically, and while flying in the air, the direction can be easily changed by the turbojet.

### BACKGROUND OF THE INVENTION

### 1. Field of the Invention

The invention relates to the technical field of aircraft, in particular to a flying saucer aircraft.

### 2. Description of the Related Art

Existing aircraft are mainly airplanes, gliders, helicopters, and hot air balloons. For saucer-shaped aircraft, they are currently mainly reflected in movies and pictures, and there are many restrictions on aircraft flying, such as the need to have a dedicated runway; on the other hand, none of the existing aircraft has a centrally symmetrical structure. When flying in the air, it encounters abnormal airflow, suffers severe interference, and has the defects of inflexible steering. Therefore, it is very necessary to create a new type of aircraft that is mainly saucer-shaped, and it can make our aircraft one more type.

### SUMMARY OF THE INVENTION

In order to solve the above technical problems, the invention provides the following technical solutions: a flying saucer aircraft, comprising a saucer body, a flying paddle, and landing brackets, wherein the middle of the saucer body is provided with an electromagnetic track in the circumferential direction; the electromagnetic track is a concave track with the central portion recessed inward; the electromagnetic track is provided with an electromagnetic levitation vehicle matched with the electromagnetic track; the flying paddle is connected to the outer surface of the electromagnetic levitation vehicle, and can be driven by the electromagnetic levitation vehicle to rotate around the saucer body along the electromagnetic track; turbojet brackets are further provided on both sides of the saucer body at the lower part of the flying paddle; the turbojet bracket is connected with a turbojet; the turbojet on one side of the saucer body is arranged vertically, and the turbojet on the other side is arranged horizontally; the landing brackets are arranged at the bottom of the saucer body, and the landing brackets are folding brackets.

As an improvement, the outside of the flying paddle is provided with a flying paddle protective cover; the flying paddle protective cover comprises a ring-shaped protective bracket arranged outside the flying paddle and in the same horizontal plane with the flying paddle; the upper and lower ends of the ring-shaped protective bracket respectively extending toward the direction of the saucer body are provided with an upper net body and a lower net body that can cover the flying paddle; the ends of the upper net body and the lower net body are connected to the saucer body.

As an improvement, the flying paddle comprises a ring-shaped flying paddle bracket arranged outside the electromagnetic levitation vehicle; the outside of the flying paddle bracket is provided with a plurality of paddle blades in the circumferential direction.

As an improvement, the paddle blades are inclined paddle blades with an included angle with the horizontal plane.

As an improvement, the saucer body comprises a central cabin body provided with the electromagnetic track; the upper part of the center cabin body is provided with an upper propulsion device placement cabin, a control center placement cabin, and a driving device placement cabin; the lower part of the center cabin is provided with a lower propulsion device placement cabin and a power supply device placement cabin for supplying power to the upper propulsion device placement cabin, the control center placement cabin, the driving device placement cabin, and the lower propulsion device placement cabin; the top of the driving device placement cabin is an openable top cabin cover.

As an improvement, the driving device placement cabin is provided with an escape ejection seat.

As an improvement, the bottom of the saucer body is provided with a flip hatch door; the inner side of the flip hatch door is provided with stairs; the saucer body is provided with an access channel from the flip hatch door to the driving device placement cabin; the access channel is provided with vertical stairs arranged along the access channel.

As an improvement, the outer surface of the upper propulsion device placement cabin and the control center placement cabin is laid with solar panels.

As an improvement, the openable top cabin cover is a transparent cabin cover.

As an improvement, the outside of the ring-shaped protective bracket is provided with a plurality of illuminating lamps.

After adopting the above structure, the invention has the following advantages: the aircraft of the application can be used as a new aircraft for transportation, travel, exploration and other activities; the aircraft of the application does not need a special runway for take-off and landing, it can take off and land vertically, and while flying in the air, the propulsion device can be controlled by the direction of the horizontal turbojet under the flying paddle protective cover or the upper and lower propulsion device cabins, so that the direction can be easily changed.

### BRIEF DESCRIPTION OF THE PREFERRED EMBODIMENTS

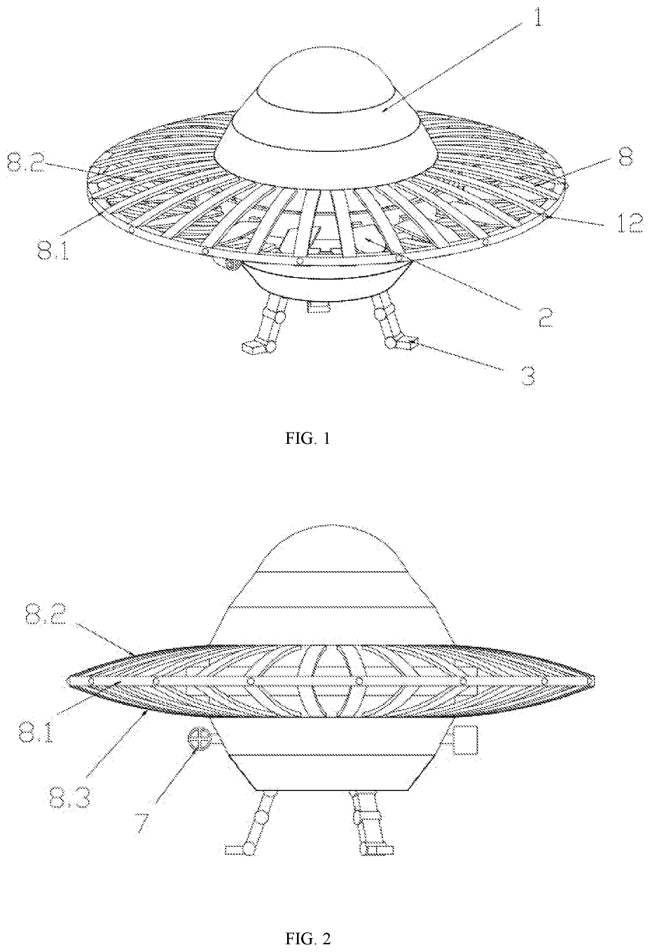

FIG. 1 is a schematic diagram of the structure of the flying saucer aircraft of the invention.

FIG. 2 is a schematic diagram of the structure of the flying paddle protective cover of the flying saucer aircraft of the invention.

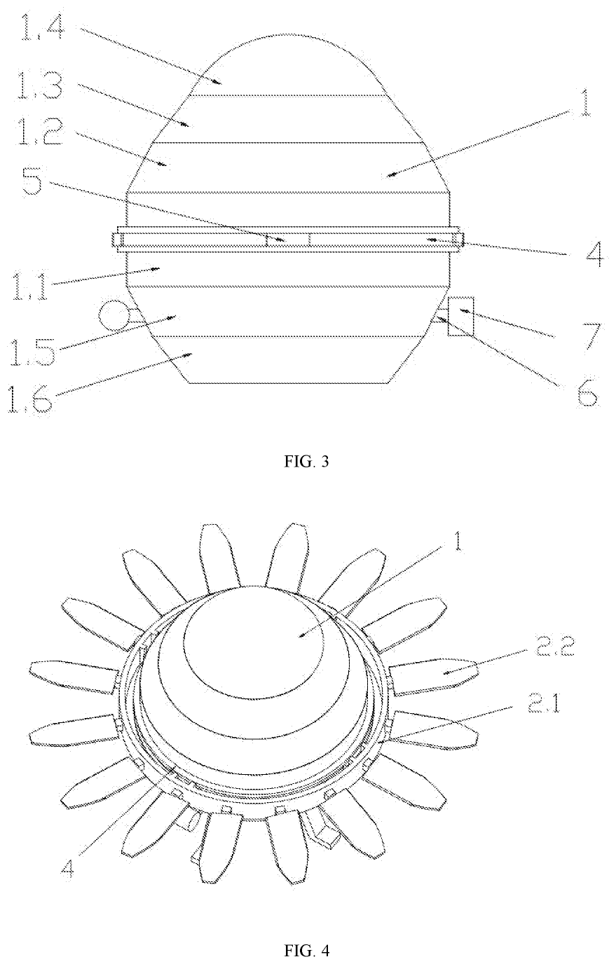

FIG. 3 is a schematic diagram of the structure of the electromagnetic track of the flying saucer aircraft of the invention.

FIG. 4 is a schematic diagram of the structure of the flying paddle of the flying saucer aircraft of the invention.

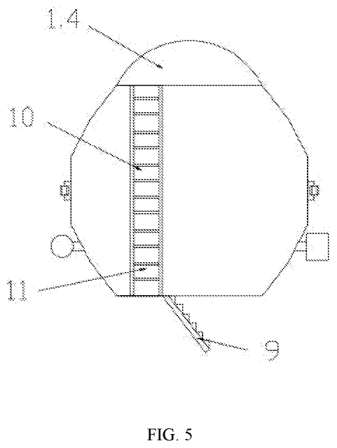

FIG. 5 is a schematic diagram of the structure of the up and down stairs of the flying saucer aircraft of the invention.

In the figures, 1 refers to the saucer body; 1.1 refers to the central cabin; 1.2 refers to the upper propulsion device placement cabin; 1.3 refers to the control center displacement cabin; 1.4 refers to the driving device placement cabin; 1.5 refers to the lower propulsion device placement cabin; 1.6 refers to the power supply device placement cabin; 2 refers to the flying paddle; 2.1 refers to the ring-shaped flying paddle bracket; 2.2 refers to the paddle blade; 3 refers to the landing bracket; 4 refers to the electromagnetic track; 5 refers to the electromagnetic levitation vehicle; 6 refers to the turbojet bracket; 7 refers to the turbojet; 8 refers to the flying paddle protective cover; 8.1 refers to the ring-shaped protective bracket; 8.2 refers to the upper net body; 8.3 refers to the lower net body; 9 refers to the flip hatch door; 10 refers to the access channel; 11 refers to the up and down stairs; 12 refers to the illuminating lamp.

### DETAILED DESCRIPTION OF THE PREFERRED EMBODIMENTS

With reference to the drawings, a flying saucer aircraft, comprising a saucer body 1, a flying paddle 2, and landing brackets 3, wherein the middle of the saucer body 1 is provided with an electromagnetic track 4 in the circumferential direction; the electromagnetic track 4 is a concave track with the central portion recessed inward; the electromagnetic track 4 is provided with an electromagnetic levitation vehicle 5 matched with the electromagnetic track 4; the flying paddle 2 is connected to the outer surface of the electromagnetic levitation vehicle 5, and can be driven by the electromagnetic levitation vehicle 5 to rotate around the saucer body 1 along the electromagnetic track; turbojet brackets 6 are further provided on both sides of the saucer body 1 at the lower part of the flying paddle 2; the turbojet bracket 6 is connected with a turbojet 7; the turbojet 7 on one side of the saucer body 1 is arranged vertically, and the turbojet on the other side is arranged horizontally; the landing brackets 3 are arranged at the bottom of the saucer body 1, and the landing brackets 3 are folding brackets.

Preferably, the outside of the flying paddle 2 is provided with a flying paddle protective cover 8; the flying paddle protective cover 8 comprises a ring-shaped protective bracket 8.1 arranged outside the flying paddle 2 and in the same horizontal plane with the flying paddle 2; the upper and lower ends of the ring-shaped protective bracket 8.1 respectively extending toward the direction of the saucer body 1 are provided with an upper net body 8.2 and a lower net body 8.3 that can cover the flying paddle 2; the ends of the upper net body 8.2 and the lower net body 8.3 are connected to the saucer body 1. The setting of the flying blade protective cover 8 does not affect air circulation, and can prevent floating objects and birds from entering the rotor blades.

Preferably, the flying paddle 2 comprises a ring-shaped flying paddle bracket 2.1 arranged outside the electromagnetic levitation vehicle 5; the outside of the flying paddle bracket 2.1 is provided with a plurality of paddle blades 2.2 in the circumferential direction.

Preferably, the paddle blades 2.2 are inclined paddle blades with an included angle with the horizontal plane.

Preferably, the saucer body 1 comprises a central cabin body 1.1 provided with the electromagnetic track 4; the upper part of the center cabin body 1.1 is provided with an upper propulsion device placement cabin 1.2, a control center placement cabin 1.3, and a driving device placement cabin 1.4; the lower part of the center cabin 1.1 is provided with a lower propulsion device placement cabin 1.5 and a power supply device placement cabin 1.6 for supplying power to the upper propulsion device placement cabin 1.2, the control center placement cabin 1.3, the driving device placement cabin 1.4, and the lower propulsion device placement cabin 1.5; the top of the driving device placement cabin 1.4 is an openable top cabin cover.

Preferably, the electromagnetic track 4 is a central recessed track, and the electromagnetic levitation vehicle 5 is embedded in the central recessed part of the electromagnetic track 4; the magnetic poles of electromagnetic levitation vehicle 5 and electromagnetic track 4 are repulsive poles; the electromagnetic levitation vehicle 5 and the electromagnetic track 4 are kept not in contact with each other in the middle and up and down, in a suspended state; when the power is turned on, the electromagnetic levitation vehicle 5 is rotated around the saucer body 1 along the electromagnetic track 4 by using the electromagnetic coil traction force provided inside the electromagnetic track 4, which drives a circle of flying paddles 2 outside the electromagnetic levitation vehicle 5 to rotate; when the rotation speed reaches a certain speed, the upward force of the flying paddle 2 is large enough to drive the entire saucer body 1 to float upward, then use the vertical turbojet under the flying paddle protective cover to slightly push up the rear of the flying saucer, which changes the flying paddle to suck air from top to bottom, to from top to back to bottom, imitating the propulsion method of a helicopter to move forward, so as to achieve the purpose of suspension and flying the flying saucer; when the flying saucer is started, the rotor blades rotate, and its strong centrifugal force will cause the entire saucer body to rotate, so at the same time, the horizontal turbojet arranged under the flying paddle protective cover is started to control the stability of the saucer body.

The direction of the horizontal turbojet arranged under the flying paddle protective cover can be adjusted by increasing and decreasing the rotation speed.

The directional control propulsion device arranged in the propulsion device cabins on the upper and lower layers of the saucer body can be set to work in left and right interactively to realize direction adjustment, for example, when turning to the left, start the direction control propulsion device on the right, and the saucer body can be turned to the left; when turning to the right, the direction control propulsion device on the left can be activated, and the saucer body is turned to the right. It can also be used in the future when the flying saucer is applied to outer space; in an environment where there is no air, it can be propelled by activating this propulsion device. The direction of the propulsion device can be adjusted by the direction of the propulsion device cabin.

The power supply group in the power supply machine room can be set as a battery pack or a nuclear power pack, and the power supply device is placed in the lower part of the saucer body. After the power supply device is installed, the flying saucer can keep the center of gravity downward, so as not to tilt or somersault.

Preferably, the driving device placement cabin 14 is provided with an escape ejection seat.

Preferably, the control center placement cabin is further provided with a large parachute and jetting device for landing the flying saucer aircraft, and its outlet is connected to the center position of the driving device placement cabin. When the flying saucer fails in the air or the power is cut off, the synchronous automatic top hatch is opened, or directly blasted, and then a large parachute is sprayed to land the flying saucer, which can greatly improve the safety of the flying saucer. If the jet of the large parachute fails, the ejection seat is ejected out of the cabin together with the seat and the pilot pulls the parachute worn on the body, throws away the seat, and makes a landing. The ejection method of military aircraft can be borrowed to ensure the safety of the pilot and the ejection posture of the pilot's head up, and then throw the parachute.

Preferably, the bottom of the saucer body 1 is provided with a flip hatch door 9; the inner side of the flip hatch door 9 is provided with stairs; the saucer body 1 is provided with an access channel 10 from the flip hatch door 9 to the driving device placement cabin 1.4; the access channel 10 is provided with simple up and down stairs 11 arranged along the access channel 10.

Preferably, the outer surface of the upper propulsion device placement cabin 1.2 and the control center placement cabin 1.3 is laid with solar panels.

Preferably, the openable top cabin cover is a transparent cabin cover.

Preferably, the outside of the ring-shaped protective bracket 8.1 is provided with a plurality of illuminating lamps, which can be turned on at night for lighting and beautification during take-off and landing. In addition, a headlight can be set at one end of the flying saucer.

Based on the structure of the invention, it can be used as a new aircraft for transportation, travel, exploration and other activities; it can be used as a spacecraft; it can be used as a flying saucer simulation toy.

The invention and the embodiments thereof are described hereinabove, and this description is not restrictive. What is shown in the drawings is only one of the embodiments of the invention, and the actual structure is not limited thereto. All in all, structural modes and embodiments similar to the technical solution of the invention without deviating from the inventive purpose of the invention made by those of ordinary skill in the art without creative design shall all fall within the protection scope of the invention.

1. A flying saucer aircraft, comprising a saucer body, a flying paddle, and landing brackets, wherein the middle of the saucer body is provided with an electromagnetic track in the circumferential direction; the electromagnetic track is a concave track with the central portion recessed inward; the electromagnetic track is provided with an electromagnetic levitation vehicle matched with the electromagnetic track; the flying paddle is connected to the outer surface of the electromagnetic levitation vehicle, and can be driven by the electromagnetic levitation vehicle to rotate around the saucer body along the electromagnetic track; turbojet brackets are further provided on both sides of the saucer body at the lower part of the flying paddle; the turbojet bracket is connected with a turbojet; the turbojet on one side of the saucer body is arranged vertically, and the turbojet on the other side is arranged horizontally; the landing brackets are arranged at the bottom of the saucer body, and the landing brackets are folding brackets.

2. The flying saucer aircraft according to claim 1, wherein the outside of the flying paddle is provided with a flying paddle protective cover; the flying paddle protective cover comprises a ring-shaped protective bracket arranged outside the flying paddle and in the same horizontal plane with the flying paddle; the upper and lower ends of the ring-shaped protective bracket respectively extending toward the direction of the saucer body are provided with an upper net body and a lower net body that can cover the flying paddle; the ends of the upper net body and the lower net body are connected to the saucer body.

3. The flying saucer aircraft according to claim 2, wherein the flying paddle comprises a ring-shaped flying paddle bracket arranged outside the electromagnetic levitation vehicle; the outside of the flying paddle bracket is provided with a plurality of paddle blades in the circumferential direction.

4. The flying saucer aircraft according to claim 3, wherein the paddle blades are inclined paddle blades with an included angle with the horizontal plane.

5. The flying saucer aircraft according to claim 1, wherein the saucer body comprises a central cabin body provided with the electromagnetic track; the upper part of the center cabin body is provided with an upper propulsion device placement cabin, a control center placement cabin, and a driving device placement cabin; the lower part of the center cabin is provided with a lower propulsion device placement cabin and a power supply device placement cabin for supplying power to the upper propulsion device placement cabin, the control center placement cabin, the driving device placement cabin, and the lower propulsion device placement cabin; the top of the driving device placement cabin is an openable top cabin cover.

6. The flying saucer aircraft according to claim 5, wherein the driving device placement cabin is provided with an escape ejection seat.

7. The flying saucer aircraft according to claim 5, wherein the bottom of the saucer body is provided with a flip hatch door; the inner side of the flip hatch door is provided with stairs; the saucer body is provided with an access channel from the flip hatch door to the driving device placement cabin; the access channel is provided with vertical stairs arranged along the access channel.

8. The flying saucer aircraft according to claim 5, wherein the outer surface of the upper propulsion device placement cabin and the control center placement cabin is laid with solar panels.

9. The flying saucer aircraft according to claim 5, wherein the openable top cabin cover is a transparent cabin cover.

10. The flying saucer aircraft according to claim 2, wherein the outside of the ring-shaped protective bracket is provided with a plurality of illuminating lamps.
